(19) United States
(12) Patent Application Publication
(10) Pub. No.: US 2023/0192243 A1
(43) Pub. Date: Jun. 22, 2023

(54) OFFSHORE TRANSFER SYSTEM WITH INTERNAL RELATIVE MOVEMENT COMPENSATION

(71) Applicant: Eagle-Access B.V., Ijmuiden (NL)

(72) Inventors: Marco Johannes Klitsie, Ijmuiden (NL); Willem Frederik Prins, Ijmuiden (NL)

(21) Appl. No.: 17/926,695

(22) PCT Filed: May 25, 2021
(86) PCT No.: PCT/EP2021/063894

§ 371 Date: Nov. 21, 2022

(30) Foreign Application Priority Data
May 26, 2020 (NL) 2025683

(51) Int. Cl. B63B 27/30; B63B 27/10; B63B 27/14; B66C 13/04

(52) U.S. Cl. CPC B63B 27/30; B63B 27/10; B63B 27/14; B66C 13/04

(57) ABSTRACT

An offshore transfer system includes an arm construction with a primary measurement system to measure and compensate for relative movement of an element relative to an external reference when the element is supported by the arm tip, as well as a secondary measurement system to measure and compensate for relative movement of the arm tip relative to the element when the element is put down and no longer supported by the arm tip.

### CROSS-REFERENCE TO RELATED APPLICATIONS

This application is the National Stage of International Application No. PCT/EP2021/063894, filed May 25, 2021, which claims the benefit of Netherlands Application No. 2025683, filed May 26, 2020, the contents of which is incorporated by reference herein.

### FIELD OF THE INVENTION

The invention relates to an offshore transfer system to transfer people and/or cargo between two objects moving relative to each other, e.g. as encountered in offshore operations, in particular in a safe manner by compensating relative movements between the two objects.

### BACKGROUND TO THE INVENTION

With the increasing number of offshore platforms and offshore wind turbines, the need for an easy and cheap system to transfer people and/or cargo to and from these offshore platforms and wind turbines, e.g. for maintenance and installation purposes, has increased.

Prior art systems for example are based on telescopically extendable gangways.

GB-2,336,828 discloses as an alternative a stabilised ship-bome support arm that carries a boom assembly with a capsule for personnel. The arm is connected via a gimbal arrangement to a mounting on a deck of a supply vessel. The arm, the boom and the capsule are controlled in position by hydraulic means, in particular rams, to be manoeuvred to a platform. In order to stabilise the position of the capsule relative to the platform the hydraulic means are dynamically controlled to compensate for movement of the vessel.

A disadvantage herewith is that the dynamic compensation is relatively slow and inaccurate. A long hydraulic chain of motion sensors, software, control equipment, lines, pumps, accumulators, valves, switches, driving engines/actuators, make it impossible in practice to keep a tip of the boom with the capsule connected thereto sufficiently still relative to movements of the vessel. Considerable residual movements always remain at the “‘compensated’” tip which make the placing of the capsule onto the platform very risky. In practice this means that the construction of GB-2,336,828 can only be used when swell is not too rough, when waves are not too high, when the wind is not too strong, when the vessel is not too movable or small, etc. Should it be desired to also use this known construction during more heavy circumstances, then the capsule either needs to be pressed downwards onto the platform either be physically connected thereto.

Another disadvantage is that in GB-2,336,828 the dynamic compensation for roll, pitch and heave is based upon the gimbal arrangement between the arm and the deck mounting. The deck mounting is positioned rotatable around a vertical axis, but a drive for this rotatability around the vertical axis does not form part of the dynamic compensation. In fact this rotatability around the vertical axis is fixed during the manoeuvring of the capsule towards the platform. This means that the compensation of GB-2,336,828 is incomplete. Longitudinal movements and rotational movements of the vessel around a vertical axis do not get compensated for when for example the arm is operative in a position substantially perpendicular to the vessel, which normally is the preferred working position.

WO-2018/034566 discloses a vessel equipped with an offshore transfer system that comprises a two-part crane arm construction with a support arm and boom and a cage hanging down by means of four cables at a crane arm tip of the boom. Both the support arm and boom are counterbalanced. The crane arm tip of the boom is compensated for all kinds of vessel motions, like pitch, roll and heave. For this a Motion Reference Unit (MRU) is provided on the vessel that autonomously registers any vessel movements.

An important advantage of this known system is that the use of counterweights reduces the necessary driving forces and thus allows to use electric drives. This provides the advantage that the system can much quicker and more accurately respond to sudden movements of the vessel or offshore object than in case of hydraulic drives. The design can also easily result in a low weight compared to prior art systems resulting in low energy consumption. A long hydraulic chain is lacking. Instead the electric drives are simple and direct, and much faster, more exact and more accurate in their operational performance. In practice it has advantageously appeared that during transfer “‘undesired’” relative movements can be reduced with a factor ten compared to other known solutions. During an offshore transfer operation the cage can be positioned with a true touch-and-go principle onto for example a landing platform of an offshore object. For example a contact span of 30 seconds is well possible.

Certain slow movements of the vessel may remain undetected by the MRU. In particular horizontal vessel movements are not always sufficiently detected, and thus also do not get compensated for. This is not a problem during transfer, an operator has enough time to manually correct for that. However, after the cage has been put down on the landing platform, such non-detected non-compensated horizontal vessel movements may become such large that they even may cause the cables via which the cage is connected to the boom to get fully tensioned again. This may even cause the boom to start dragging along the cage over the landing platform, which may lead to damage of the cage and landing platform, but even worse may even lead to dangerous situations for persons that get transferred.

This problem may be overcome by adding satellite navigation to the MRU. This however is complex and expensive, and still not entirely failsafe.

WO-2012/161584 shows a hoisting crane on an oil rig for picking and placing pieces of cargo onto a floating vessel. Here compensations for heave, pitch and roll movements of the vessel as well as for swinging movements of the piece of cargo at the end of a hoisting wire are foreseen, for which a sensor system with a camera is provided underneath the tip of the crane boom. Transfer of people is not foreseen, and the piece of cargo gets unlocked as soon as possible after it has landed.

### BRIEF DESCRIPTION OF THE INVENTION

The present invention aims to overcome those disadvantages at least partly or to provide a usable alternative. In particular the present invention aims to provide a further improved offshore transfer system with an element supported by a motion compensated arm construction, which system is not only reliable and failsafe during transfer, but also when the element thereof has been temporarily put down on another offshore object.

This aim is achieved by an offshore transfer system according to the present invention. The system comprises a base with a stationary base part and a moveable base part that is rotatable relative to the stationary base part about a substantially vertical first axis, an arm construction, an element, a primary measurement system, an actuator system, and a control system. The arm construction is mounted to the moveable base part such that the arm construction is rotatable relative to the moveable base part about a substantially horizontal second axis. The element is configured to be supported by an arm tip of the arm construction. The primary measurement system is configured to measure any possibly occurring “‘undesired’” relative movements of the element relative to an external reference at least when the element is lifted up and has its weight carried by the arm tip. Those situations are also referred to as transfer operations. The actuator system is configured to rotate the moveable base part relative to the stationary base part using a first actuator assembly, and to rotate the arm construction relative to the moveable base part using a second actuator assembly. The control system is configured to drive the actuator system in dependency of an output of the primary measurement system to, at least during such transfer operations, compensate for measured “‘undesired’” relative movements of the element relative to the external reference.

With “‘undesired’” relative movement it is to be understood an unintentional part of a moving of the element relative to the external reference caused by two objects between which the people and/or cargo need to be transferred, moving relative to each other, for example caused by waves, wind etc. acting upon at least one of them. With “‘desired’” relative movement it is to be understood an intentional part of a moving of the element relative to the external reference because of the actuator system being driven to have the arm construction manoeuvre the element between the two objects.

According to the inventive thought the system further comprises a secondary measurement system that is configured to measure relative movement of the arm tip relative to the element at least when the element is put down and no longer has its weight carried by the arm tip. Those situations mostly occur during so-called landings when the element is temporarily landed on a landing platform or the like of the second object. With this the control system then is further configured to, at least during such landings, drive the actuator system in dependency of an output of the secondary measurement system to compensate for any measured relative movements of the arm tip relative to the element.

Thus, owing to the invention, on top of or besides the ‘“external reference”’ primary measurements and complementary primary compensations of “‘undesired’” movements of the element relative to a landing platform or the like during said transfer operations, advantageously also ‘“internal reference”’ secondary measurements and complementary secondary compensations of “‘undesired’” movements of the arm tip relative to the element can now get performed during temporary landings of the element on a landing platform or the like of the second object. Those landed periods can be considered as being most critical situations, because then persons need to step in and out of for example a cage of the element and/or need to assist in unloading cargo from a pending/hoisting frame of the element.

The secondary measurement system and complementary secondary compensations of the arm tip induced by its secondary measurements, only needs to be active during said landed periods, that is to say at least starting after the element has been put down and at least until it gets lifted up again by the arm construction. In principle the primary measurement system does not need to be active during said landed periods. The secondary measurement system then is well able to deliver the required input to the control system to drive the actuator system in such a way that the secondary measured relative movements of the arm tip relative to the element get compensated for.

Thanks to the fact that this secondary measurement system makes use of an ‘“internal reference”’ between the arm tip and the element, it is advantageously possible to land the element on whatever position on the landing platform or the like. No specific landing area is required for being able to perform the secondary measurements and complementary secondary compensations.

The ‘“internal reference”’ secondary measurement system has proven to even be able to reliably detect slow movements between the two offshore objects that are not always reliably detectable by the primary measurement system with its ‘“external reference”’. This makes it possible to increase the safety of the system during the landed periods. The safety of personnel during such landed periods now no longer has to be dependent on permanent observations and manual corrections by an operator on the first object, and also does not have to be made dependent on expensive vulnerable satellite navigation.

The element can remain in place on landing platforms or the like while the arm tip then at a same time can efficiently remain being automatically positioned straight above the element by means of the secondary measurements and complementary secondary compensations.

In a preferred embodiment the element can be connected to the arm tip by means of one or more flexible elongate tension members, like ropes, chains or slings. Those flexible connections have the advantage that they shall automatically be tensioned as soon as the arm construction is controlled for lifting up the element, and that they shall automatically be released from this tension as soon as the element has been put down. The tension release is important because it gives the arm tip some slack to move relative to the element, instead of immediately starting to exert pulling forces thereupon which otherwise might lead to dangerous situations like the element falling over or getting dragged along back and forth. This slack also gives the control system some time to respond on the relative undesired movements measured by the secondary measurement system. The maximum amount of slack cq response time for the secondary compensation to be executed can be set by choosing suitable lengths for the flexible elongate tension members, for example between 100-200 cm.

It is noted that the connection with flexible elongate tension members that either get tensioned with the weight load of the element, either get released from this weight load with a certain amount of play, is also advantageous because then it is not necessary to each time have to disconnect the element from and connect it again to the arm construction during landed periods and transfer operations. It is noted however that the connection preferably still also is of a disconnectable type such that the element also can be replaced or dropped off somewhere for longer periods of time.

Further it is noted that the invention can also advantageously be used in combination with other types of connections, for example magnetic ones or vacuum operated suction ones, between the arm tip and element. For those it goes that during each landed period they may get temporarily disconnected. The invention then is able to offer the advantage that the arm tip automatically can be compensated to stay in position relative to the element. This in turn makes it more easy to reconnect again as soon as it is desired to start a new transfer operation.

According to the invention, the secondary measurement system is configured to particularly measure relative movement of the arm tip of the arm construction in a horizontal face relative to the element during at least said landed periods. Thus it is possible to particularly compensate for slow horizontal drifting movements of one or both objects that may occur during said landed periods, and that are more likely to remain undetected by the primary measurement system.

In order to perform such relative horizontal movement measurements, the secondary measurement system may comprise a detectable unique target pattern on either the element or the arm tip, that is representative for the exact horizontal position of the arm tip above the element and that is detectable by one or more detectors, like image recognition, that are mounted to the other one of the element and the arm tip.

According to the invention, the secondary measurement system comprises a plurality of distance sensors at a plurality of horizontally spaced positions for measuring vertical distances between the arm tip and the element at each of those spaced positions. Changes in one or more of those respective measured vertical distances then can be used as indication of relative movement of the arm tip in said horizontal face relative to the element, such that a secondary horizontal compensation for such relative horizontal movements can automatically be ordered by the control system. As an additional advantage the changes in those respective measured vertical distances then can also be used in combination as indication of relative movement of the arm tip in the vertical direction relative to the element, such that a secondary vertical compensation for such relative vertical movements can also automatically be ordered by the control system.

Preferably at least three or four distance sensors are being provided at such horizontally spaced positions relative to each other that they are positioned in a triangle or square. This makes it possible to determine accurate directions in said horizontal face for the measured relative movements for which the control system needs to control the required compensations.

In addition thereto or in the alternative the distance sensors may comprise transmitters and receivers, in particular laser measuring tools, mounted to either one of the arm tip and the element, and one or more reflective targets mounted to the other one of the arm tip and the element. Thus, contactless distance measurements are possible, which are less vulnerable for harsh offshore weather conditions and possible deteriorations.

According to the invention the distance sensors comprise transmitters and receivers, in particular laser measuring tools, mounted to either one of the arm tip and the element, and one or more reflective targets mounted to the other one of the arm tip and the element. Thus, contactless distance measurements are possible, which are less vulnerable for harsh offshore weather conditions and possible deteriorations.

It is for example possible to provide one disc-shaped reflective target of uniform thickness. As soon as one or more of the distance sensors then ‘“drop off”’ the raised disc-shaped target, this can be compensated for by steering the arm tip in the opposite direction.

In addition thereto or in the alternative the reflective target may comprises a concave, convex or cone shape. This has the advantage that every undesired movement of the arm tip then automatically shall lead to each of the distance sensors starting to measure a changed distance.

Preferably the reflective target may comprise a spherical hollow. This brings along the advantage that only horizontal and vertical shifting movements of the arm tip can get compensated for, because roll and pitch rotations of the arm tip around its own longitudinal axis no longer have to lead to different distances being measured by the distance sensors.

The arm construction for example can be formed by a motion compensated telescopic arm. This can be a telescopic arm that is used as a telescopic crane arm construction, or as a telescopic gangway/walkway. The invention can also be used in combination with a two-part crane arm construction with a support arm and boom. More preferably the invention is used in combination with a counterbalanced, lightweight, electrically operated two-part crane arm construction as shown and described in WO-2018/034566, which is incorporated here by reference.

The element can be a reference element that solely has the function of serving as reference after having been placed down on a landing platform or the like. The element can also be a load support element that is configured to support the people and/or cargo during transfer. For example such a load support element can be a cage with at least one access door.

Preferably, the first object on which the offshore transfer system is provided, is formed by a vessel, in particular a vessel that is equipped with a dynamic positioning system for keeping it substantially at a same location relative to the second object during said landed periods. Thus many transfers can be performed from one and the same ship to and from for example offshore platforms and/or offshore windmill masts. The second object however can also be formed by another vessel, and it is also possible for the offshore transfer system to be mounted on for example a fixed offshore construction itself.

Further preferred embodiments of the invention are described herein.

The invention also relates to a method for transferring people or cargo between a first offshore object and a second offshore object.

### BRIEF DESCRIPTION OF THE DRAWINGS

The invention shall now be explained in more detail below by means of describing some exemplary embodiments in a non-limiting way with reference to the accompanying drawings, in which:

FIG. 1 schematically shows a vessel with an offshore transfer system according to an embodiment of the invention in front of an offshore mast during a transfer operation;

FIG. 2 shows an enlarged partial perspective view of FIG. 1;

FIGS. 3a and b show enlarged partial perspective and front views of FIG. 1 just before landing;

FIGS. 4a and b show views according to FIGS. 3a and b during a landed period;

FIG. 5 shows a view according to FIG. 4b with a crane arm tip of a boom having undergone a rolling or pitching vessel movement;

FIG. 6 shows a view according to FIG. 5 with the crane arm tip of the boom shifted out of horizontal position;

FIGS. 7a and b show a perspective and side view of a variant with a telescopic gangway and a reference element just before landing; and

FIGS. 8a and b show views according to FIGS. 7a and b during a landed period.

### DETAILED DESCRIPTION OF THE INVENTION

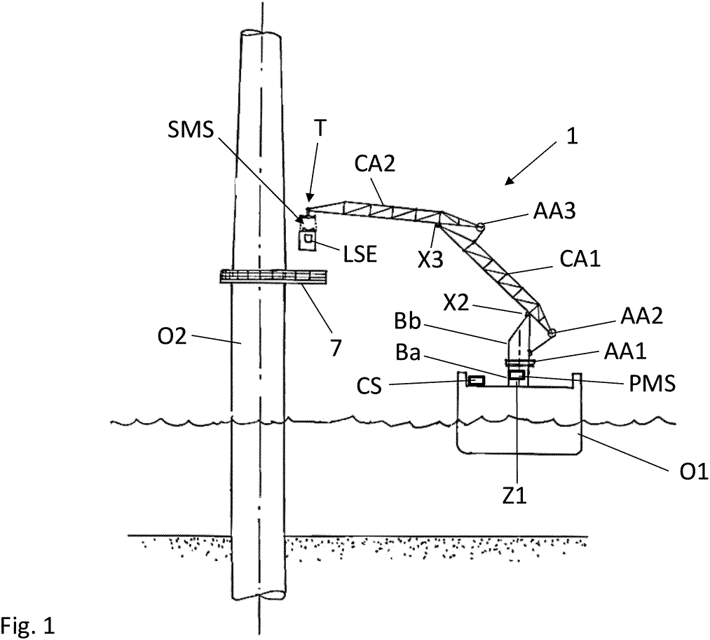

FIG. 1 depicts an offshore transfer system 1 for transferring people and/or cargo during offshore operations according to an embodiment of the invention. Offshore operations may include the transfer of people and/or cargo from a vessel O1 to a fixed offshore construction O2, e.g. an oil drilling platform, an offshore windmill, or other fixed offshore installation, and/or vice versa. The system 1 is mounted on a deck of the vessel O1.

The system 1 comprises a base B, a two-part crane arm construction CA with a support arm CA1 and a boom CA2, a load support element LSE, a primary measurement system PMS, an actuator system, and a control system CS.

The base B comprises a stationary base part Ba mounted to the deck of the vessel O1, and a moveable base part Bb that is rotatable relative to the stationary base part Ba about a substantially vertical first axis Z1.

To rotate the moveable base part Bb relative to the stationary base part Ba, the actuator system comprises a first actuator assembly AA1, here embodied in the form of a slewing ring with external tooth gear arranged on the stationary base part Ba cooperating with an electric drive that drives a gear engaging with the slewing ring, wherein the electric drive and the gear are arranged on the moveable base part Bb.

The support arm CA1 has a proximal end and a distal end. The moveable base part Bb comprises a first support beam to which the support arm CA1 can be connected at a location in between the proximal and distal ends of the support arm CA1. The support beam defines a substantially horizontal second axis X2 allowing the support arm CA1 to rotate relative to the moveable base Bb about said second axis X2.

In order to rotate the support arm CA1 relative to the moveable base part Bb, the actuator system is provided with a second actuator assembly AA2 comprising in this embodiment, an electrically driven winch arranged on the proximal end of the support arm CA1 and a corresponding cable that extends between the winch on the support arm CA1 and the moveable base Bb.

Rotation of the support arm CA1 is thus possible by paying out or hauling in the cable using the respective winch.

The boom CA2 has a proximal end and a distal end. The distal end of the boom CA2 is also referred to as the crane arm tip T of the crane arm construction CA. The boom CA2 is connected to the distal end of the support arm CA1 at a location in between the proximal and distal end of the boom CA2. The support arm CA1 at this location defines a substantially horizontal third axis X3 allowing the boom CA2 to rotate relative to the support arm CA1 about said third axis X3.

In order to rotate the boom CA2 relative to the support arm CA1, the actuator system AA is provided with a third actuator assembly AA3 comprising in this embodiment, an electrically driven winch arranged on the proximal end of the boom CA2 and a corresponding cable that extends between the winch on the boom CA2 and the distal end of the support arm CA1.

Rotation of the boom CA2 is thus possible by paying out or hauling in the cable using the respective winch.

The load support element LSE is configured to be supported hanging down from the crane arm tip T and is configured to support the people and/or cargo during transfer.

The load support element LSE may be permanently connected to the crane arm tip T, but may also be releasably connected thereto allowing to use the system from time to time with different types of load support elements LSE depending on the type of transfer. Further, it allows to leave the load support element LSE behind after transfer. This allows for instance to limit the use of the entire system 1 and/or for the vessel O1 carrying the system to perform other tasks, possibly at another location, in between subsequent transfers.

As mentioned before, system 1 is preferably used in cases in which there are undesired relative movements between two objects preventing an easy transfer of people and/or cargo between those two objects. In the embodiment of FIG. 1 this relative movement is caused by sea- and/or wind-induced movement of the vessel O1 while the fixed offshore construction O2 is not movable.

As a result of these undesired relative movements, the load support element LSE may start to move along with movements of the vessel O1 relative to the fixed offshore construction O2 during transfer operations, that is to say during (operator) controlled transfer displacement of the load support element LSE through the air towards a fenced landing platform 7 of the fixed offshore construction O2.

In order to compensate for the undesired relative movements, the system 1 is provided with the primary measurement system PMS configured to measure directly or indirectly the undesired relative movement of the load support element LSE relative to an external reference. This can be done in various ways, including direct and indirect ways, for instance:
1) by measuring the relative motions of the vessel O1 or stationary base part Ba using e.g. gyroscopes. The earth itself then acts as external reference, but as the fixed offshore construction O2 is directly arranged on the ground, the fixed offshore construction O2 can also be considered to be the external reference; and/or
2) by measuring relative movements of the vessel O1 directly with respect to the fixed offshore construction O2, e.g. by using laser measurements systems, for instance based on laser interferometry in which a laser beam is reflected of between the fixed offshore construction O2 and the vessel O1.

Relative movements may also be measured by measuring acceleration, velocity and/or position relative to the reference as long as these measurements can be used to compensate for the relative movements.

In FIG. 1 the primary measurement system PMS is formed by a so-called Motion Reference Unit, that is mounted to the stationary base part Ba.

An output of the primary measurement system PMS, which is representative for the undesired relative movements, is fed to the control system CS. Another input may be user input, which may represent desired movements or relative positions of the load support element LSE.

The control system CS is configured to drive the actuator system AA in dependency of the output of the primary measurement system PMS to compensate for the undesired relative movement of the vessel O1 and thus also of the load support element LSE. As a result, if there is no desired transfer displacement of the load support element LSE, the load support element LSE will be stationary relative to the fixed construction O2, even when the vessel O1 is kept dynamically positioned relative to the fixed offshore construction O2, because the vessel O1 is then still prone to undesirably move due to wave and wind action (roll, pitch, heave, yaw, surge and sway).

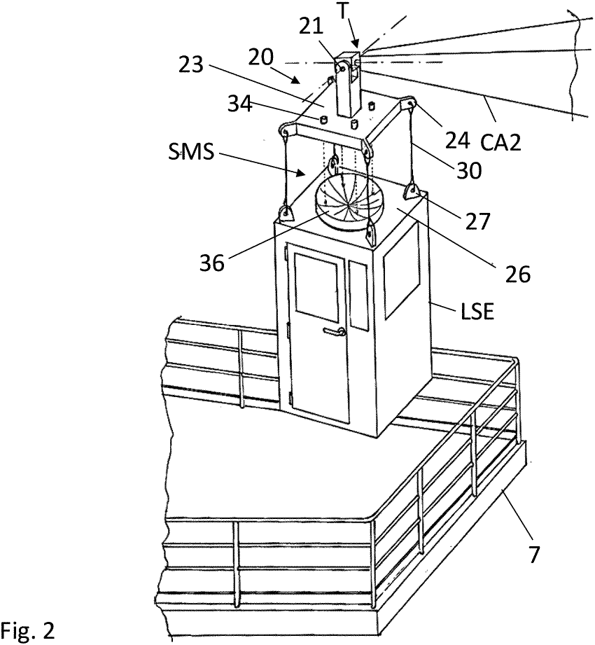

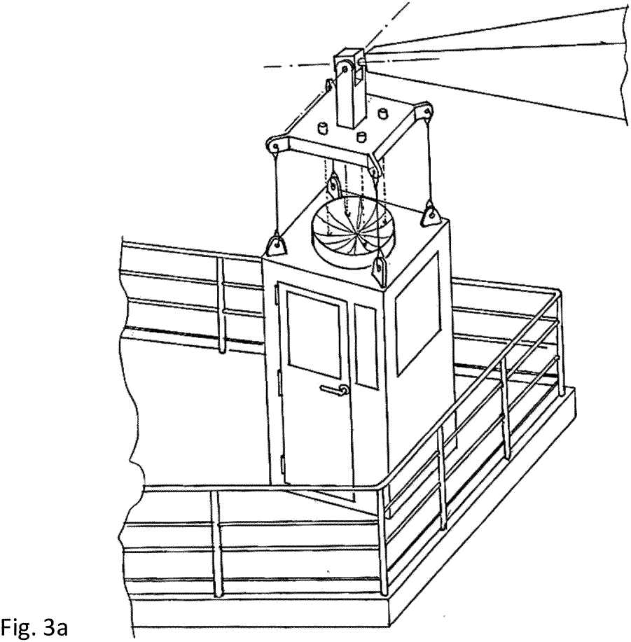

The primary compensation of the undesired relative movements, leads to a motion compensated crane arm tip T, which makes it much easier for an operator or user to have the control system CS accurately control the crane arm construction CA and thus the position of the crane arm tip T and the load support element LSE relative to the fixed construction O2 during said transfer operation. This can particularly be advantageous when at the end of said transfer operation, the load support element LSE needs to be carefully placed over and behind a fence of the landing platform 7. See FIGS. 2, 3a and 3b.

The control system CS provides drive signals to the electric drives of the first, second and third actuator assemblies AA1, AA2, AA3.

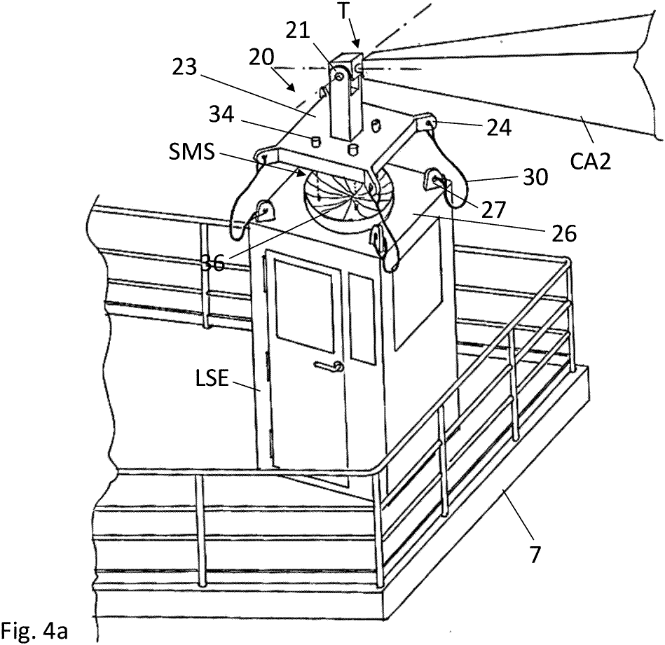

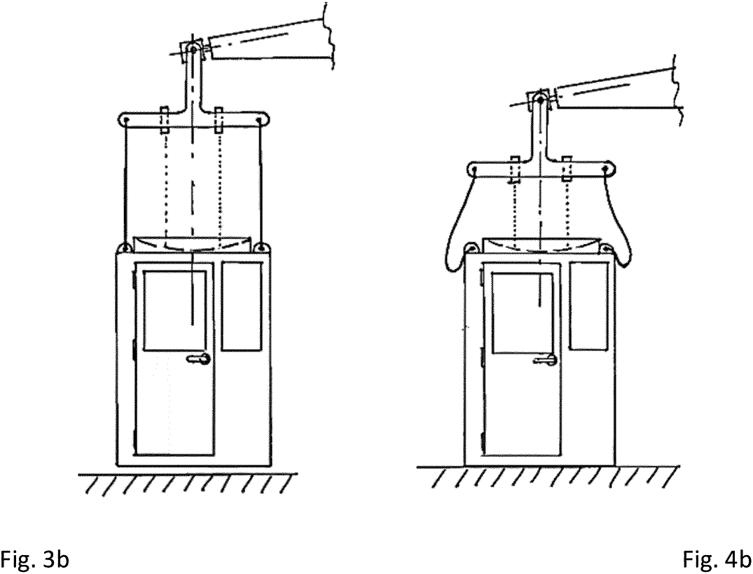

Due to the offshore situation, it is expected that there will be undesired movements to be compensated continuously, both during the transfer operation as shown in FIGS. 1-3, as well as during landed periods as shown in FIGS. 4-6. This means that the actuator assemblies AA1, AA2, AA3 are continuously driven to move the moveable part Bb of the base Bb (and everything supported thereby), the support arm CA1 and the boom CA2.

To keep the driving forces within limits, the support arm CA1 may comprises a counterweight at the proximal end of the support arm CA1, and the boom CA2 may comprise a corresponding counterweight at the proximal end of the boom CA2.

The support arm CA1 and the boom CA2 are preferably configured such that the counterweights do not fully compensate the moment applied to the respective distal ends of the support arm CA1 and the boom CA2 so that the cables of respectively the second and third actuator assemblies AA2, AA3 are kept taut at all times of the operation.

In FIGS. 2-6 it can be seen that a pending frame 20 is mounted as a pendulum, that is to say rotatable around two perpendicular axes, via a gimbal/cardan connection 21 to the crane arm tip T. The gimbal/cardan connection 21 can be provided with suitable dampers in order to prevent the load support element LSE from starting to swing too much during heavy weather transfer operations. The pending frame 20 here comprises a rectangular plate 23 with four ears 24 at its corners.

The load support element LSE is embodied as a cage with at least one access door. The load support element LSE has a flat rectangular top side 26 with four ears 27 at its corners.

The ears 27 of the load support element LSE are connected with the ears 24 of the pending frame 20 by means of four flexible elongate tension members 30. Those tension members 30 here are formed by steel wire cables. Other types of flexible tensionable members, like ropes, chains, slings, wires, hoisting bands, or the like, are also possible.

According to the invention, a secondary measurement system SMS is provided between the crane arm tip T and the load support element LSE. This secondary measurement system SMS is configured to directly measure any undesired relative movement of the crane arm tip T relative to the load support element LSE.

For that, the secondary measurement system SMS here comprises four distance sensors 34 that are provided at equally spaced positions on the plate 23. The distance sensors 34 can be of various types, for example infrared, sonic, or the like. Here laser measuring tools are used for emitting laser beams straight downward form the plate 23 towards the top side 26 of the load support element LSE. On this top side 26 a disc-shaped reflective target 36 is provided for reflecting the transmitted sensor signals back again towards the distance sensors 34. The reflective target 36 comprises a spherical hollow. Thus a stepped raised transition of several cm thickness is formed between the reflective target 36 and the top side 26. Furthermore, a gradually increasing reflective surface is provided inside the spherical hollow.

The secondary measurement system thus enables exact positioning of the pending frame 20 at the crane arm tip T of the crane arm construction CA relative to the top side 26 of the load support element LSE during periods that the load support element LSE has been put down on the landing platform 7. This is important because the primary measurement system PMS, here formed by the MRU, is well able to detect quick vessel movements, but is not always able to accurately detect slow movements of the vessel during such landed periods.

An output of the secondary measurement system SMS has appeared more suitable to measure and detect such relative slow movements.

The control system CS is configured to drive the actuator system AA in dependency of the output of the secondary measurement system PMS to compensate for the secondary measured undesired relative slow movements of the vessel O1 and/or of the crane arm construction CA and/or of the crane arm tip T and/or of the pending frame 20 connected thereto during said landed periods. As a result, if there is no desired movement of the crane arm construction CA, then the crane arm tip T can thus be kept substantially stationary above the load support element LSE, even when for example the dynamically positioned vessel O1 slowly drifts away.

Thus, this secondary compensation of the undesired relative movements, makes it much safer for personnel to exit or enter a cage of the load support element LSE during the landed periods.

In FIGS. 4a and 4b a landed situation is shown in which the load support element LSE has been put down on a floor of the landing platform 7, after which the crane arm tip T has been lowered somewhat further to an aimed spaced distance between the plate 23 of the pending frame 20 and the raised reflective target 36 on top of the load support element LSE. This automatically causes the four flexible elongate tension members 30 to no longer be tensioned, and get hanging down as loose loops with a certain amount of play for each of them. This in turn causes the load support element LSE to no longer run the risk of each time get submitted to residual tip movement of the crane arm tip T.

The aimed spaced distance preferably is chosen such that a distance between a centre of rotation of the gimbal/cardan connection 21 and the spherical hollow gets to be substantially the same as a radius R of the spherical hollow.

In FIGS. 4a and 4b the most optimum landed situation is shown. In this most optimum situation the pending frame 20 is positioned with its central axis aligned with a central axis of the reflective target 36. Each of the four distance sensors 34 then measure a same distance towards the target 36.

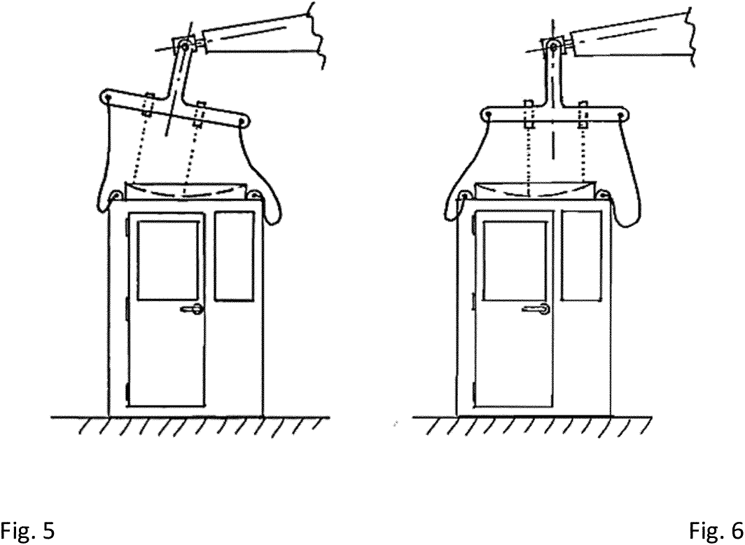

Owing to the spherical hollow that is provided in the target 36, the distance measurements do not get influenced by changing pendulum angles of the pending frame 20 relative to the crane arm tip T. See FIG. 5.

The target 36 is dimensioned somewhat larger than a coverage of the spaced apart four distance sensors 34. As long as the centre of rotation of the gimbal/cardan connection 21 keeps on being positioned straight above the centre axis of the spherical hollow, the distance sensors 34 shall keep on measuring a substantially same distance and no secondary compensation needs to be forced upon the crane arm construction CA by the control system CS.

FIG. 6 however shows a situation in which the distance sensors 34 have started measuring changes in distances because of undesired sideways drifting movement in the horizontal face of the crane arm tip T relative to the landed put down load support element LSE. This then is immediately recognized by the control system CS as undesired relative movement in the horizontal face for which compensation needs to be performed.

The direction of the needed compensation in the horizontal face can be determined by the control system CS out of the fact which ones of the distance sensors 24 have started measuring increased distances and which ones have started measuring decreased distances. Thus any unwanted offset of the crane arm tip T relative to the load support element LSE is measured through interpretation of the four distance measurements and leads to correction of the tip position relative to the centre line of the load support element LSE.

It is also possible to use the secondary measurements for having the control system CS determine if the aimed spaced distance between the plate 23 of the pending frame 20 and the reflective target 36 on top of the load support element LSE is still within acceptable limits or not. If not, then this is seen as a too large undesired relative upward or downward movement in the vertical direction for which a compensation in the opposite direction needs to be performed. This can for example be done by means of averaging the respective measured distances.

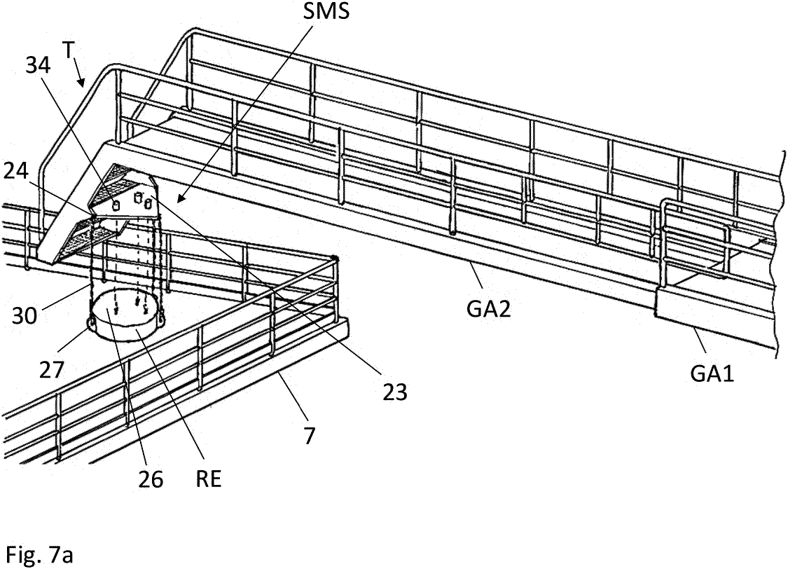

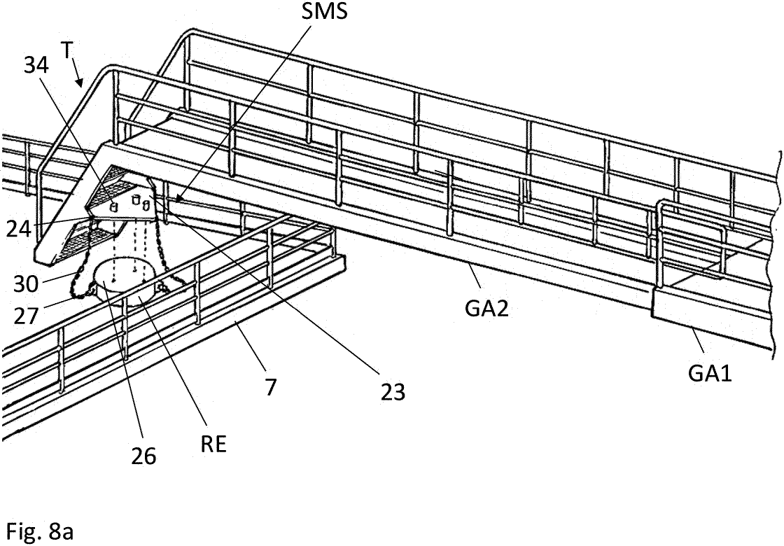

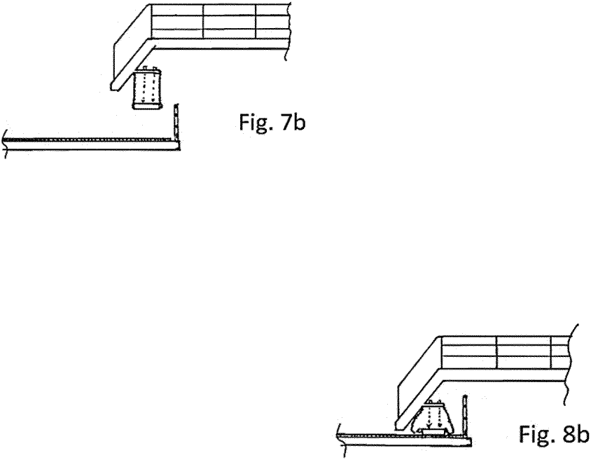

FIGS. 7a and 7b depict a gangway type offshore transfer system for transferring people and/or cargo during offshore operations according to another embodiment of the invention. The system is mounted via a base on a deck of the vessel. The system comprises a two-part gangway arm construction GA with a first arm GA1 that has a second arm GA2 movably connected thereto such that it can telescope in and out in order to lengthen or shorten the gangway in its longitudinal direction. The base is similar to the one of FIG. 1, and comprises a stationary base part and a movable base part that is rotatably connected around a vertical axis to the stationary base part. The first arm GA1 has a proximal end that is rotatably connected around a horizontal axis to the moveable base part.

The second arm GA2 has a distal end that is referred to as the gangway arm tip T of the gangway arm construction GA.

An actuator system is provided for actively steering the degrees of freedom of the gangway, that is to say have it rotate around the horizontal and vertical axis and have it telescope in and out.

A reference element RE is hanging down from the arm tip T and is configured to be placed on a landing platform 7. The reference element RE is permanently connected to the arm tip T.

The system is preferably used in cases in which there are undesired relative movements between two objects preventing an easy transfer of people and/or cargo over the gangway from the vessel to the landing platform 7 and vice versa.

In order to compensate for the undesired relative movements, the system again is provided with a primary measurement system, control system and actuator system, that together are configured to measure the undesired relative movement of the reference element RE or arm tip T relative to an external reference and compensate for them. This can be done in the same manner as for the FIG. 1 embodiment.

The primary compensation of the undesired relative movements, leads to a motion compensated gangway arm tip T, which makes it much easier for an operator or user to have the control system accurately control the gangway arm construction GA and thus the position of the gangway arm tip T and the reference element RE relative to the fixed construction during said transfer operation. This can particularly be advantageous when during a transfer operation, the gangway tip and reference element RE need to be carefully placed over and behind a fence of the landing platform 7.

Due to the offshore situation, it is expected that there will be undesired movements to be compensated continuously, both during the transfer operation as shown in FIG. 7, as well as during landed periods as shown in FIG. 8.

In FIG. 7 it can be seen that a fixed frame is mounted to the gangway arm tip T. The fixed frame here comprises a plate 23 with connection points 24 at its corners.

The reference element RE is embodied as a solid block. The reference element RE has a flat circular top side 26 with a same number of ears 27 as the number of connection points 24.

The ears 27 of the reference element RE are connected with the ears 24 of the plate 23 by means of flexible elongate tension members 30.

According to the invention, a secondary measurement system SMS is provided between the arm tip T and the reference element RE. This secondary measurement system SMS is configured to directly measure any undesired relative movement of the arm tip T relative to the reference element RE.

For that, the secondary measurement system SMS here comprises at least three distance sensors 34 that are provided at equally spaced positions on the plate 23.

The secondary measurement system enables exact positioning of the frame 20 at the arm tip T of the gangway arm construction GA relative to the top side 26 of the reference element RE during periods that the reference element RE has been put down on the landing platform 7.

The control system is configured to also drive the actuator system in dependency of the output of the secondary measurement system PMS to compensate for secondary measured undesired relative slow movements of the vessel during said landed periods. As a result, the arm tip T can thus be kept substantially stationary above the reference element RE, even when for example the vessel slowly drifts away.

Thus, this secondary compensation of the undesired relative movements, makes it much safer for personnel to step of or onto the gangway GA during the landed periods.

In FIGS. 8a and 8b a landed situation is shown in which the reference element RE has been put down on a floor of the landing platform 7, after which the arm tip T has been lowered somewhat further to an aimed spaced distance between the plate 23 and the top side 26 of the reference element RE. This automatically causes the flexible elongate tension members 30 to no longer be tensioned, and get hanging down as loose loops with a certain amount of play for each of them. This in turn causes the reference element RE to no longer run the risk of each time get submitted to residual tip movement of the arm tip T.

The aimed spaced distance preferably is chosen such that a distance between the outer end of the gangway and the landing platform 7 is small enough for a person to easily step down from the gangway onto the landing platform and vice versa.

In FIGS. 8a and 8b the most optimum landed situation is shown. In this most optimum situation the plate 23 is positioned with its central axis aligned with a central axis of the reference element RE. Each of the at least three distance sensors 34 then measures a same distance towards the top side 26 of the reference element RE.

The top side 26 is dimensioned somewhat larger than a coverage of the spaced apart at least three distance sensors 34. As soon as one or two of the distance sensors 34 ‘“drops off”’ the top side 26 of the reference element RE, then a larger distance shall be measured which is a clear indication of undesired sideways drifting movement in the horizontal face of the arm tip T relative to the landed put down reference element RE. This then is immediately recognized by the control system as undesired relative movement in the horizontal face for which compensation needs to be performed.

The direction of the needed compensation in the horizontal face can be determined by the control system out of the fact which ones of the distance sensors 24 have started measuring said increased distances. Thus any unwanted offset of the arm tip T relative to the reference element RE is measured through interpretation of the at least three distance measurements and leads to correction of the tip position relative to the centre line of the reference element RE.

It is also possible to use the secondary measurements for having the control system determine if the aimed spaced distance between the plate 23 and the top side of the reference element RE is still within acceptable limits or not. If not, then this is seen as a too large undesired relative upward or downward movement in the vertical direction for which a compensation in the opposite direction needs to be performed. This can for example be done by means of averaging the respective measured distances.

Besides the shown and described embodiments, numerous variants are possible. For example the dimensions and shapes of the various parts can be altered. Also it is possible to make combinations between advantageous aspects of the shown embodiments.

Although the first rotation axis Z1 is defined as being substantially vertical and the second and third axis X2, X3 are defined as being substantially horizontal, an alternative definition may be that the second and third axis are parallel to each other, but perpendicular to the first axis, or that the first, second and third axis are oriented such that a 3DOF, where each DOF is a translation, positioning system is obtained.

It should be understood that various changes and modifications to the presently preferred embodiments can be made without departing from the scope of the invention, and therefore will be apparent to those skilled in the art. It is therefore intended that such changes and modifications be covered by the appended claims.

1. An offshore transfer system to transfer people and/or cargo during offshore operations, comprising:
a base with a stationary base part and a moveable base part that is rotatable relative to the stationary base part about a substantially vertical first axis;
an arm construction;
an element;
a primary measurement system (PMS);
an actuator system; and
a control system,
wherein the arm construction is mounted to the moveable base part such that the arm construction is rotatable relative to the moveable base part about a substantially horizontal second axis,
wherein the element is configured to be supported by an arm tip of the arm construction during transfer operations,
wherein the primary measurement system is configured to measure relative movement of the element relative to an external reference during transfer operations when the element is supported by the arm tip,
wherein the actuator system is configured to rotate the moveable base part relative to the stationary base part using a first actuator assembly, and to rotate the arm construction relative to the moveable base part using a second actuator assembly, and
wherein the control system is configured to drive the actuator system in dependency of an output of the primary measurement system to compensate for measured relative movement of the element relative to the external reference during transfer operations when the arm tip supports the element,
wherein the system further comprising:
a secondary measurement system,
wherein the secondary measurement system is configured to measure relative movement of the arm tip relative to the element during landed periods when the element is put down and no longer supported by the arm tip,
wherein the control system is further configured to drive the actuator system in dependency of an output of the secondary measurement system to compensate for measured relative movement of the arm tip relative to the element during landed periods when the element is put down and no longer supported by the arm tip,
wherein the secondary measurement system is configured to measure relative movement of the arm tip at least in a horizontal face relative to the element when the element is put down and no longer supported by the arm tip,
wherein the control system is further configured to drive the actuator system in dependency of an output of the secondary measurement system to compensate for measured relative movement of the arm tip in said horizontal face relative to the element during landed periods when the element is put down and no longer supported by the arm tip,
wherein the secondary measurement system comprises distance sensors for measuring vertical distances between the arm tip and the element,
wherein the distance sensors comprise transmitters and receivers mounted to either one of the arm tip and the element, and one or more reflective targets mounted to the other one of the arm tip and the element.

2. (canceled)

3. (canceled)

4. The offshore transfer system according to claim 1, wherein at least three or four distance sensors are provided positioned relative to each other in a triangle or square.

5. (canceled)

6. The offshore transfer system according to claim 1, wherein the distance sensors are laser measuring tools.

7. The offshore transfer system according to claim 1, wherein the one or more reflective targets comprise portions of different heights.

8. The offshore transfer system according to claim 1, wherein the reflective target comprises a spherical hollow.

9. The offshore transfer system according to claim 1, wherein the element is connected to the arm tip by means of one or more flexible elongate tension members, like ropes, chains or slings.

10. The offshore transfer system according to claim 1, wherein the arm construction is a crane arm construction with a crane arm tip and comprises:
a support arm having a proximal end and a distal end; and
a boom having a proximal end and a distal end that forms the crane arm tip,
wherein the support arm at a location in between the proximal and distal end of the support arm is mounted to the moveable part of the base such that the support arm is rotatable relative to the moveable part about a substantially horizontal second axis,
wherein the boom at a location in between the proximal and distal end of the boom is mounted to the distal end of the support arm such that the boom is rotatable relative to the support arm about a substantially horizontal third axis, and
wherein the actuator system is configured to rotate the support arm relative to the moveable base part using the second actuator assembly, and to rotate the boom relative to the support arm using a third actuator assembly (AA3).

11. The offshore transfer system according to claim 1, wherein the element is a load support element that is configured to support the people and/or cargo during transfer, and in particular is a cage with at least one access door.

12. The offshore transfer system according to claim 1, wherein the arm construction is a telescopic gangway arm construction.

13. A vessel provided with an offshore transfer system according to claim 1.

14. A method for transferring people or cargo between a first offshore object and a second offshore object, in particular between a vessel and a fixed offshore construction, using an offshore transfer system according to one of the preceding claims, said method comprising the following steps:
moving the element during transfer operations from the first object to the second object while:
the arm tip supports the element,
the primary measurement system measures relative movement of the first object relative to the second object, and
the control system drives the actuator system in dependency of an output of the primary measurement system to compensate for measured relative movement of the first object relative to the second object;
placing the element on the second object such that the element is no longer supported by the arm tip during landed periods while:
allowing the people or cargo to transfer to or from the second object,
the secondary measurement system measures relative movement of the arm tip relative to the element (LSE; RE), and
the control system drives the actuator system in dependency of an output of the secondary measurement system to compensate for measured relative movement of the arm tip relative to the element.
